(19) United States
(12) Patent Application Publication
(10) Pub. No.: US 2026/0042012 A1
(43) Pub. Date: Feb. 12, 2026

(54) VIRTUAL WORLD-BASED CAPTURE INFORMATION DISPLAY METHOD AND APPARATUS, DEVICE, AND MEDIUM

(71) Applicant: TENCENT TECHNOLOGY (SHENZHEN) COMPANY LIMITED, Shenzhen (CN)

(72) Inventors: Yang Chen, Shenzhen (CN); Siyu Mu, Shenzhen (CN)

(73) Assignee: TENCENT TECHNOLOGY (SHENZHEN) COMPANY LIMITED, Shenzhen (CN)

(21) Appl. No.: 19/357,843

(22) Filed: Oct. 14, 2025

Related U.S. Application Data
(63) Continuation of application No. 18/662,251, filed on May 13, 2024.
Application No. 18/662,251 is a continuation of application No. PCT/CN2023/111925, filed on Aug. 9, 2023.

(30) Foreign Application Priority Data
Aug. 19, 2022 (CN) 202211001669.3

(51) Int. Cl. A63F 13/5375; A63F 13/56; A63F 13/822

(52) U.S. Cl. CPC A63F 13/5375; A63F 13/822; A63F 13/56

(57) ABSTRACT

A method for displaying capture information in a virtual world, performed by a computer device, includes displaying a pet virtual character within a virtual world; displaying a status bar corresponding to status information of the pet virtual character, the status information including a status value corresponding to at least one of an energy value or health points; determining a capture threshold for the pet virtual character; displaying a prompt element on the status bar at a position corresponding to the capture threshold; receiving a capture operation performed by a master virtual character on the pet virtual character; and displaying capture success in response to the capture operation when the pet virtual character is in a capturable state, wherein the pet virtual character is in the capturable state when the status value is less than the capture threshold.

### CROSS-REFERENCE TO RELATED APPLICATIONS

This application is a Continuation of U.S. application Ser. No. 18/662,251, filed on May 13, 2024 in the United States Patent and Trademark Office, which is a continuation application of International Application No. PCT/CN2023/111925 filed on Aug. 9, 2023, which claims priority to Chinese Patent Application No. 202211001669.3 filed with the China National Intellectual Property Administration on Aug. 19, 2022, the disclosure of each being incorporated by reference in their entireties.

### FIELD

The disclosure relates to the field of virtual worlds, and in particular, to a virtual world-based capture information display method and apparatus, a device, and a medium.

### BACKGROUND

A role-playing game (RPG) is a game type. In this type of game, a player is responsible for playing a character in a realistic world or a fictional world.

In an RPG in the related art, the player plays a pet trainer. In an open world, the player captures various pets, and then interacts with pets such as raising pets, using pets to pick, and using pets to fight. When a pet is captured, an energy value of the pet is displayed on a user interface. Based on the energy value being high, there may be almost no chance of successful capture; and based on the energy value being low, there may be a higher success rate in capturing the pet.

A capture process may not only be related to the energy value of the pet. However, because the player can only see the energy value of the pet on the user interface, the player can only use the energy value of the pet as a basis for capturing the pet. However, the pet being in a low energy state does not represent that the pet can be captured. Manners in the related art rely on guessing and repeated attempts of the player, resulting in a very vague process of capturing the pet.

### SUMMARY

Provided are a virtual world-based capture information display method and apparatus, a device, and a medium.

According to an aspect of the disclosure, a method for displaying capture information in a virtual world, performed by a computer device, includes displaying a pet virtual character within a virtual world; displaying a status bar corresponding to status information of the pet virtual character, the status information including a status value corresponding to at least one of an energy value or health points; determining a capture threshold for the pet virtual character; displaying a prompt element on the status bar at a position corresponding to the capture threshold; receiving a capture operation performed by a master virtual character on the pet virtual character; and displaying capture success in response to the capture operation when the pet virtual character is in a capturable state, wherein the pet virtual character is in the capturable state when the status value is less than the capture threshold.

According to an aspect of the disclosure, an apparatus for displaying capture information in a virtual world, the apparatus includes at least one memory configured to store program code; and at least one processor configured to read the program code and operate as instructed by the program code, the program code including pet display code configured to cause at least one of the at least one processor to display a pet virtual character within a virtual world; status bar display code configured to cause at least one of the at least one processor to display a status bar corresponding to status information of the pet virtual character, the status information including a status value corresponding to at least one of an energy value or health points; threshold determination code configured to cause at least one of the at least one processor to determine a capture threshold for the pet virtual character; prompt display code configured to cause at least one of the at least one processor to display a prompt element on the status bar at a position corresponding to the capture threshold; capture operation code configured to cause at least one of the at least one processor to receive a capture operation performed by a master virtual character on the pet virtual character; and capture success code configured to cause at least one of the at least one processor to display capture success in response to the capture operation when the pet virtual character is in a capturable state, wherein the pet virtual character is in the capturable state when the status value is less than the capture threshold.

According to an aspect of the disclosure, a non-transitory computer-readable storage medium storing program code which, when executed by at least one processor of a computer device, causes the at least one processor to at least display a pet virtual character within a virtual world; display a status bar corresponding to status information of the pet virtual character, the status information including a status value corresponding to at least one of an energy value or health points; determine a capture threshold for the pet virtual character; display a prompt element on the status bar at a position corresponding to the capture threshold; receive a capture operation performed by a master virtual character on the pet virtual character; and display capture success in response to the capture operation when the pet virtual character is in a capturable state, wherein the pet virtual character is in the capturable state when the status value is less than the capture threshold.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of a virtual world according to some embodiments.

FIG. 2 is a schematic diagram of a virtual world according to some embodiments.

FIG. 3 is a structural block diagram of a computer system according to some embodiments.

FIG. 4 is a schematic diagram of capturing a pet virtual character of a related art according to some embodiments.

FIG. 5 is a schematic diagram of capturing a pet virtual character of a related art according to some embodiments.

FIG. 6 is a schematic diagram of capturing a pet virtual character of a related art according to some embodiments.

FIG. 7 is a schematic diagram of capturing a pet virtual character of a related art according to some embodiments.

FIG. 8 is a flowchart of a virtual world-based capture information display method according to some embodiments.

FIG. 9 is a flowchart of a virtual world-based capture information display method according to some embodiments.

FIG. 10 is a schematic diagram of a virtual world-based capture information display method according to some embodiments.

FIG. 11 is a schematic diagram of a virtual world-based capture information display method according to some embodiments.

FIG. 12 is a schematic diagram of a virtual world-based capture information display method according to some embodiments.

FIG. 13 is a flowchart of a virtual world-based capture information display method according to some embodiments.

FIG. 14 is a schematic diagram of a virtual world-based capture information display method according to some embodiments.

FIG. 15 is a schematic diagram of a virtual world-based capture information display method according to some embodiments.

FIG. 16 is a flowchart of a virtual world-based capture information display method according to some embodiments.

FIG. 17 is a structural block diagram of a virtual world-based capture information display apparatus according to some embodiments.

FIG. 18 is a structural block diagram of a computer device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

First, terms involved in some embodiments are briefly introduced.

Virtual world: It is a virtual world displayed (provided) by an application program running on a terminal. The virtual world may be a simulated environment of a real world, or may be a semi-simulated and semi-fictional environment, or may be a completely fictional environment. The virtual world may be any one of a two-dimensional virtual world, a 2.5-dimensional virtual world, and a three-dimensional virtual world. This is not limited. An example in which the virtual world is a three-dimensional virtual world is used for description in some embodiments.

Master virtual character: It is a movable object played by a player in a virtual world. The master virtual character may be a virtual character, a virtual animal, a cartoon character, or the like, for example, a character or an animal displayed in the three-dimensional virtual world. In some embodiments, the master virtual character is a three-dimensional model created based on a skeletal animation technology. A master virtual character may have a shape and a volume in the three-dimensional virtual world, and occupies some space in the three-dimensional virtual world.

Pet virtual character: It is a movable object controlled by artificial intelligence (AI) in the virtual world. The pet virtual character may be a virtual creature, a virtual animal, a virtual monster, a virtual elf, a virtual pet, or the like, for example, a movable object in the form of an animal or in another form displayed in the three-dimensional virtual world. At least one of interactive operations such as capturing, raising, and upgrading may be performed on the pet virtual character by the master virtual character. The pet virtual character may assist the master virtual character in performing at least one of interactive operations such as collecting, fighting, and changing a plot.

In a turn-based role-playing game (RPG) of the related art, the player plays a virtual character in a realistic world or the virtual world. The turn-based RPG provides two types of maps: a world map and a battle map. In a non-battle scenario, the virtual character moves around the world map, for example, plays, captures a pet virtual character, collects a treasure box, and collects a virtual item. In a battle scenario, the virtual character controls a captured pet virtual character in the battle map, and engages in a turn-based battle with an enemy unit (for example, a non-player character (NPC), an AI-controlled monster, or a pet virtual character captured by another character in the game).

In the related art, because the world map and the battle map are two completely different maps, based on switching between a world scenario (or referred to as a non-battle scenario) and a battle scenario, a user interface may display map content with large differences. The player may clearly feel a startling difference between the two different maps. In the related art, to mitigate this effect, a transition animation is often displayed during switching, but the transition animation has limited efficacy to this end.

In some embodiments, an innovative turn-based RPG mechanism is provided. The turn-based RPG combines a traditional world map and the battle map into one. The battle map is a sub-map dynamically determined from the world map during a battle. In this way, when switching between the world scenario (or referred to as the non-battle scenario) and the battle scenario, there are no large differences in the map content displayed in the user interface, thereby avoiding the startling effect that exists in the related art. In addition, the turn-based RPG also allows an environment (weather, time, a plot, and the like) in the virtual world to affect the master virtual character, the pet virtual character, and a combat process. Reversely, the master virtual character, the pet virtual character, and the combat process also affect the environment in the virtual world. In this way, a turn-based battle process is organically integrated into the virtual world. It is no longer two torn parts, but forms a whole.

A game process of the turn-based RPG includes: a capture process and a battle process.

Capture process:
1. Discover a pet virtual character in a virtual scenario. When the master virtual character approaches the pet virtual character within a range, a capture scenario face to face with the pet virtual character is displayed in the virtual scene picture. The pet virtual character may remain still, move around constantly, or intimidate and attack the master virtual character.
2. Prepare a spherical container item, for example, select a spherical container item.
3. Use the spherical container item to aim at the pet virtual character. Capture-related information such as capture difficulty (represented by a color, for example, a difficulty represented by green<a difficulty represented by orange<a difficulty represented by red) is displayed on a body of the pet virtual character. Attributes (including a name, a gender, a level, and a comprehensive attribute value) of the pet virtual character are displayed on the virtual scene picture. An aiming circle is further displayed on the virtual scene picture, and the aiming circle shrinks and expands cyclically over time. When the aiming circle shrinks, throwing the spherical container item to the pet virtual character has a higher chance of successful capture.
4. Throw the spherical container item to the pet virtual character to capture the pet virtual character, and a throwing effect may be implemented through a touch control on a touch screen.

If a throwing position and/or throwing timing are incorrect, the capture fails and a prompt for failure capture is displayed. If both the throwing position and the throwing timing are correct, but a level or strength of the master virtual character is not enough, the capture fails and the prompt for failure capture is displayed. If both the throwing position and the throwing timing are correct, and the level or strength of the master virtual character is enough, the capture is successful, and a prompt for successful capture, rewards (for example, an experience point, and a newly acquired skill) for successful capture, and attributes (for example, a name, a gender, a height, a weight, a number, a skill, a rarity, and a personality characteristic) of the captured pet virtual character are displayed.

Battle process: It may be a single battle, a double battle, or a team battle.
1. Select a pet virtual character for battle.
2. Display a battle scenario and select a skill to be used by the pet virtual character.
3. Control the touch control on the touch screen to cast the skill.
4. Display a skill animation effect.

In some embodiments, the turn-based RPG has innovative design in at least the following parts:

### World Map

The world map includes a plurality of plots. A plot may be a polygonal plot. The polygonal plot may be any one of a square, a rectangle, and a hexagon. For example, a plot may be a 50 cm×50 cm square. A plot may have its own surface property. The surface property includes grass, stone, water, and the like. In addition, the plurality of plots included in the world map may be of the same type, or may be a combination of a plurality of different types of plots.

### Battle Map

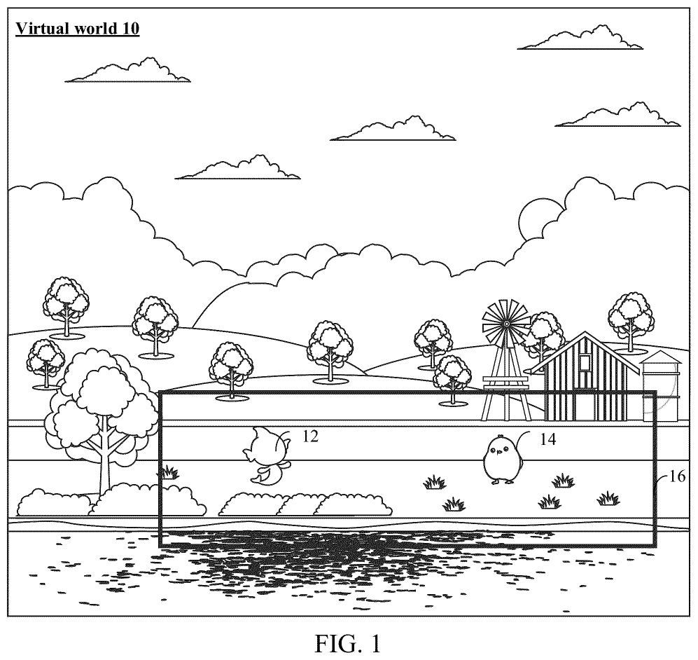

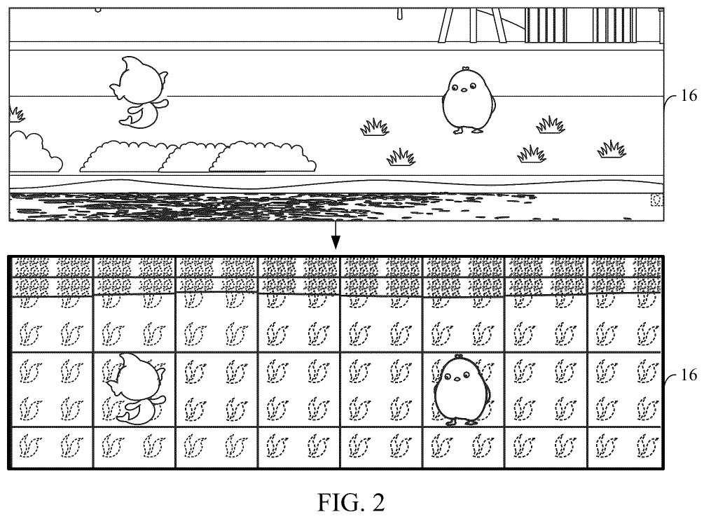

Referring to FIG. 1 and FIG. 2, in a virtual world 10, based on a first pet virtual character 12 encountering a second pet virtual character 14 at a position in the world map and entering a battle, one or more plots in the world map within a range centered on a reference position determined by the first pet virtual character 12 may be determined as a battle map 16. The reference position is a position at which the first pet virtual character 12 is located, or a suitable combat position closest to the first pet virtual character 12. In some embodiments, the battle map 16 includes all plots within a circular range with the reference position as a center and a predetermined length as a radius. In some embodiments, the battle map 16 includes all plots within a rectangular range of a predetermined length and width centered on the reference position.

### World Scenario and Battle Scenario

The world scenario refers to a scenario corresponding to the world map. When the world scenario is displayed in the user interface, one or more plots in the world map may be displayed in the user interface. For example, the user interface displays one or more plots in which the master virtual character or the pet virtual character is currently located in the world map, as well as some interface elements related to the foregoing displayed plots, the master virtual character, the pet virtual character, and the like.

The battle scenario refers to a scenario corresponding to the battle map. When the battle scenario is displayed in the user interface, the battle map may be displayed in the user interface, for example, all or part of the plots included in the battle map are displayed. For example, the user interface displays one or more plots in which the master virtual character or the pet virtual character is currently located in the battle map, as well as some interface elements related to the foregoing displayed plots, the master virtual character, the pet virtual character, and the like.

The world scenario or the battle scenario may be switched to the other, for example, the world scenario may be switched to the battle scenario, or the battle scenario may be switched to the world scenario.

When the world scenario and the battle scenario are displayed, a virtual camera may use different shooting views. For example, based on the world scenario being displayed, the virtual camera may shoot the world scenario from a view (for example, a first-person view or a third-person view of the master virtual character) of the master virtual character to obtain a display picture of the world scenario. Based on the battle scenario being displayed, the virtual camera may shoot the battle scenario from an intermediate view (for example, the virtual camera is located in the middle and obliquely above two combatants) to obtain the display picture of the battle scenario. In some embodiments, in the world scenario and the battle scenario, in addition to the foregoing shooting views being different, allowed user operations may also be different. For example, based on the world scenario being displayed, the user may be allowed to manually adjust the view, and the user is allowed to control the movement of the master virtual character or the pet virtual character. When the battle scenario is displayed, the user is not allowed to manually adjust the view, the user is not allowed to control the movement of the master virtual character or the pet virtual character, and the like. Through the foregoing manner, the user can make a distinction in perception between the world scenario and the battle scenario. However, because the world scenario and the battle scenario share the same world map, and the battle map used in the battle scenario may be one or more plots in the world map, switching between the world scenario and the battle scenario may not be startling, but may be smooth and natural.

### Potential Energy

The potential energy is an element or attribute or identifier in the virtual world that affects the battle. The potential energy includes at least one of a grass type, a fire type, a water type, a stone type, an ice type, an electric type, a poison type, a light type, a ghost type, a demon type, a normal type, a martial type, a cute type, a fantasy type, an insect type, a wing type, a dragon type, and a mechanical type.

### Aura

In the virtual world, there is an abstract element that affects an ability of at least one visual element of the plot, the master virtual character, and the pet virtual character within a range. An aura is an abstract element in the virtual world that appears continuously, randomly, following the master virtual character, following the pet virtual character, triggered by a skill, or triggered by an item. Auras, for example, a flame aura, a light aura, a mass healing aura, and a buff aura, are invisible or visible in the virtual world.

### Capture of Pet Virtual Character

The master virtual character owns at least one spherical container item, and the spherical container item is configured for capturing, storing, raising, or releasing the pet virtual character. The master virtual character captures the pet virtual character by throwing out an empty spherical container item, or releases the pet virtual character by throwing out a spherical container item storing the pet virtual character. For example, the spherical container item is referred to as a poke ball or a baby ball or a Bubbleboo.

For the capture of the pet virtual character, based on the capture threshold being greater than an energy value of the pet virtual character, the pet virtual character may be in the “capturable state. ” Prompt information is displayed on the user interface that the pet virtual character is in the “capturable state” to assist the player in capturing the pet virtual character. The capture threshold is affected by factors such as an operation of the player, weather, an environment, and the number of times the pet virtual character has been captured. For example, the player may change the capture threshold through operations such as feeding fruits, using a skill, and attacking, and the capture threshold may change based on conditions such as weather and time in a game. In addition, the prompt information is configured for assisting in encouraging the player to capture the pet virtual character by friendly means such as feeding food and changing the environment, rather than using a battle manner, which reflects a design purpose of the pet virtual character being a good friend of the master virtual character.

The released pet virtual character may stay in the virtual scenario and interact with the master virtual character, may also perform a collection behavior, and may also battle with another pet virtual character. In addition, the released pet virtual character interacts with the environment in the virtual world, for example, activates a potential energy mechanism to change the potential energy of a surrounding environment, obtains a virtual item in a treasure chest with an attribute lock, and affects the attributes of the plot in the virtual world, such as ignites grass and freezes lakes.

The spherical container item further simulates a physical characteristic of a real spherical object, which can bounce based on encountering an obstacle and can also float on the water.

### Battle Process Changes World Environment

During the turn-based battle between pet virtual characters, the skill casted by the pet virtual character affects the environment of the virtual world, which is synchronized from the battle scenario to the world scenario. For example, the pet virtual character enters a battle in the battle scenario. The pet virtual character casts a fire skill, a grassland plot in the battle scenario is ignited, and the ignited grassland plot is synchronized to the world scenario. Further, based on the environment of the plot changing, the pet virtual character may be affected.

### World Environment Changes Battle Process

During the turn-based battle between pet virtual characters, the pet virtual character is affected by the environment in the virtual world, for example, a skill damage of the pet virtual character is affected or a skill display effect of the pet virtual character is affected. For example, the environment in the virtual world includes the environment of the plot and the weather environment. These two aspects comprehensively affect a degree to which the pet virtual character likes the environment. For example, the degree to which the pet virtual character likes the environment include the following different levels: strong affinity, weak affinity, indifference, weak resistance, and strong resistance.

If the pet virtual character likes both environments (plot and weather), a stronger affinity effect is obtained; if the pet virtual character only likes one environment and does not dislike the other environment, a weaker affinity effect is obtained; if the pet virtual character likes one environment and dislikes the other environment, no effect is obtained; if the pet virtual character only dislikes one environment and does not dislike the other environment, a weaker resistance effect is obtained; and if the pet virtual character dislikes both environments, a strong conflict effect is obtained.

During the battle, the server or the client may need to obtain the environment regularly (for example, every round) and determine an effect of the environment on the pet virtual character.

### Position Change in Turn-Based Battle

In a traditional turn-based battle, standing positions of our pet virtual character and an enemy pet virtual character on the battle map are fixed, or stationary. In some embodiments, based on the pet virtual characters battling, both the attacker and the attacked party may not be stationary, or displacement may occur.

When the pet virtual character is the attacker, active displacement occurs. If the first position currently located by the pet virtual character satisfies a skill cast condition, the pet virtual character may cast the skill in place at the first position. If the foregoing first position does not meet the skill cast condition, before the skill is casted, the pet virtual character is controlled to actively move from the first position to a second position that meets the skill cast condition, and the pet virtual character casts the skill at the second position. The foregoing second position may be referred to as a valid battle point, which refers to a position that satisfies the skill cast condition of the pet virtual character. In some embodiments, based on casting the skill, the pet virtual character moves to a third position. The third position may be the same as or may be different from the foregoing first position. The foregoing third position may be referred to as a valid standing point, which is a position of the pet virtual character based on the casting of the skill being completed. In addition, the foregoing skill cast condition may be related to factors such as the pet virtual character, the skill, and an environment.

When the pet virtual character is the one being attacked, a passive displacement is produced. When the pet virtual character is attacked by a skill, there is a displacement process of being repulsed. For example, the pet virtual character is currently in the first position and is attacked by the skill at the first position. The pet virtual character may move from the first position to a fourth position, and the fourth position may be determined based on factors such as the pet virtual character being an attacked party, the pet virtual character being an attacker, a taken skill, and an environment.

In addition, as the position of the pet virtual character changes, the environment (including the environment of the plot and the weather environment) in which the pet virtual character is located may also change, which affects the battle of the pet virtual character.

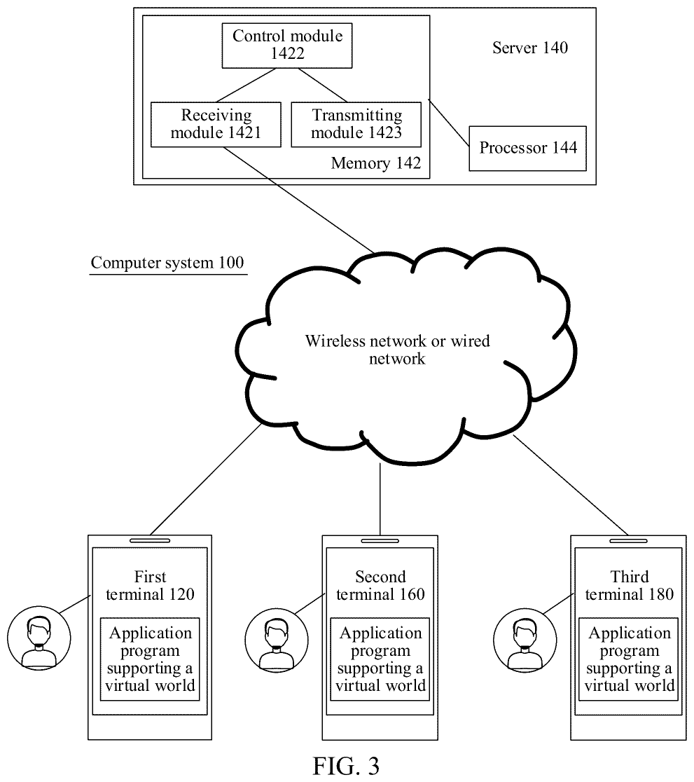

FIG. 3 is a structural block diagram of a computer system according to some embodiments. The computer system 100 includes a computer device, and the computer device may be: a first terminal 120, a server 140, a second terminal 160, and a third terminal 180.

An application program supporting a virtual world is installed and run on the first terminal 120. The application program may be any one of a three-dimensional map program, a virtual reality (VR) application program, an augmented reality (AR) program, an RPG program, a turn-based game program, and a turn-based RPG program. The first terminal 120 is a terminal used by a first user. The first user uses the first terminal 120 to control a first virtual character located in the virtual world to perform activities, and the first virtual character may be used as a master virtual character. The activities include but are not limited to at least one of adjusting body postures, walking, running, jumping, riding, driving, aiming, picking up, capturing a pet virtual character, controlling a pet virtual character, raising a pet virtual character, using a pet virtual character to pick, using a pet virtual character to fight, using a throwing item, and attacking another virtual character. For example, the first virtual character is a first virtual character, such as a simulated character object or a cartoon character object. For example, the first user controls the first virtual character to perform activities through an UI control on a virtual world picture, and the first user controls the first virtual character to throw the pet virtual character through the UI control on the virtual world picture.

An application program supporting a virtual world is installed and run on the second terminal 160. The application program may be any one of a three-dimensional map program, a virtual reality application program, an augmented reality program, an RPG program, a turn-based game program, and a turn-based RPG program. The second terminal 160 is a terminal used by a second user. The second user uses the second terminal 160 to control a second virtual character located in the virtual world to perform activities, and the second virtual character may also be used as the master virtual character. The activities include but are not limited to at least one of adjusting body postures, walking, running, jumping, riding, driving, aiming, picking up, capturing a pet virtual character, controlling a pet virtual character, raising a pet virtual character, using a pet virtual character to pick, using a pet virtual character to fight, using a throwing item, and attacking another virtual character. For example, the second virtual character is a second virtual character, such as a simulated character object or a cartoon character object. For example, the second user controls the second virtual character to perform activities through the UI control on the virtual world picture, and the second user controls the second virtual character to throw the pet virtual character through the UI control on the virtual world picture.

An application program supporting a virtual world is installed and run on the third terminal 180. The application program may be any one of a three-dimensional map program, a virtual reality application program, an augmented reality program, an RPG program, a turn-based game program, and a turn-based RPG program. The third terminal 180 is a terminal used by a third user. The third user uses the third terminal 180 to control a third virtual character located in the virtual world to perform activities. The third virtual character may also be used as the master virtual character. The activities include but are not limited to at least one of adjusting body postures, walking, running, jumping, riding, driving, aiming, picking up, capturing a pet virtual character, controlling a pet virtual character, raising a pet virtual character, using a pet virtual character to pick, using a pet virtual character to fight, using a throwing item, and attacking another virtual character. For example, the third virtual character is a third virtual character, such as a simulated character object or a cartoon character object. For example, the third user controls the third virtual character to perform activities through the UI control on the virtual world picture, and the third user controls the third virtual character to throw the pet virtual character through the UI control on the virtual world picture.

In some embodiments, the first virtual character, the second virtual character, and the third virtual character are located in the same virtual world. The first virtual character and the second virtual character may belong to different camps, and the second virtual character and the third virtual character may belong to the same camp.

In some embodiments, the application programs installed on the first terminal 120, the second terminal 160, and the third terminal 180 are the same, or the application programs installed on the three terminals are the same type of application programs in different operating system platforms (Android or iOS). The first terminal 120 may refer to one of a plurality of terminals, the second terminal 160 may refer to one of a plurality of terminals, and the third terminal 180 may refer to one of a plurality of terminals. In some embodiments, the first terminal 120, the second terminal 160, and the third terminal 180 are merely used as an example for description. The device types of the first terminal 120, the second terminal 160, and the third terminal 180 are the same or different. The device types include: at least one of a smartphone, a smartwatch, a smart television, a tablet computer, an e-book reader, an MP3 player, an MP4 player, a laptop portable computer, and a desktop computer. An example in which the terminal includes a smartphone is used for description in some embodiments.

The first terminal 120, the second terminal 160, and the third terminal 180 are respectively connected to the server 140 through a wireless network or a wired network.

The server 140 includes at least one of one server, a plurality of servers, a cloud computing platform, and a virtualization center. For example, the server 140 includes a processor 144 and a memory 142. The memory 142 further includes a receiving module 1421, a control module 1422, and a transmitting module 1423. The receiving module 1421 may be configured to receive a request transmitted by the client, for example, a request to view a position of an enemy virtual character; the control module 1422 may be configured to control the rendering of the virtual world picture; and the transmitting module 1423 may be configured to transmit a response to the client, for example, transmit a position of the third virtual character to the client. The server 140 may be configured to provide a backend service for an application program supporting a three-dimensional virtual world. In some embodiments, the server 140 is responsible for primary computing work, and the first terminal 120, the second terminal 160, and the third terminal 180 are responsible for secondary computing work; or the server 140 is responsible for secondary computing work, and the first terminal 120, the second terminal 160, and the third terminal 180 are responsible for primary computing work; or the server 140, the first terminal 120, the second terminal 160, and the third terminal 180 perform collaborative computing by using a distributed computing architecture.

A person skilled in the art may learn that numbers of the first terminals 120, the second terminals 160, and the third terminals 180 may be more or fewer. For example, there may be only one first terminal 120, one second terminal 160, and one third terminal 180, or there may be dozens of or hundreds of first terminals 120, second terminals 160, and third terminals 180 or more. The number and the device types of the first terminal 120, the second terminal 160, and the third terminal 180 are not limited in some embodiments.

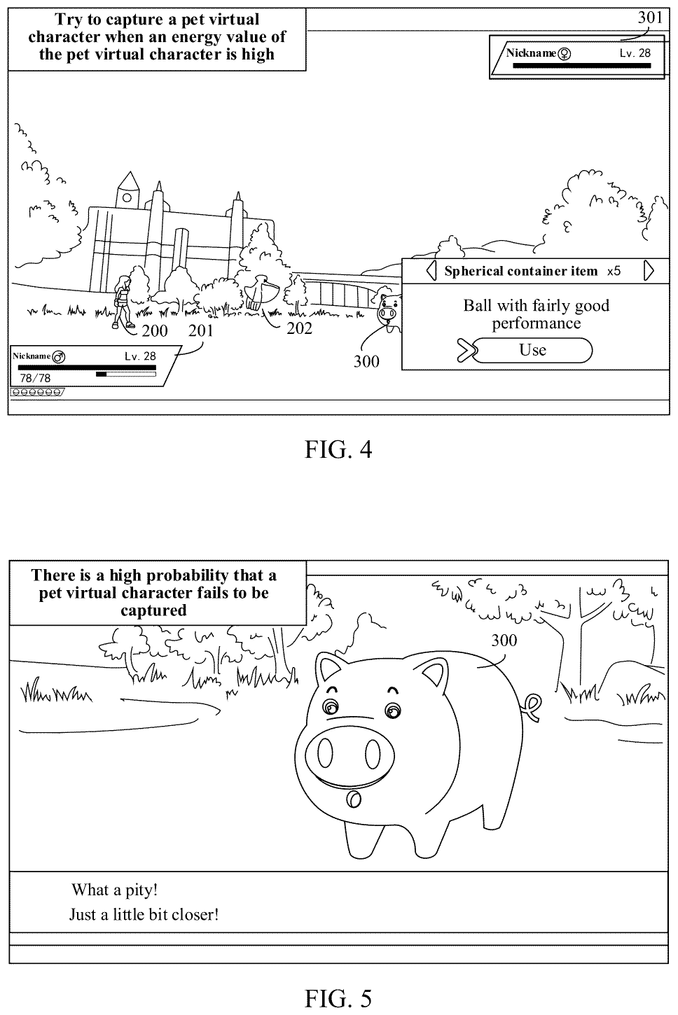

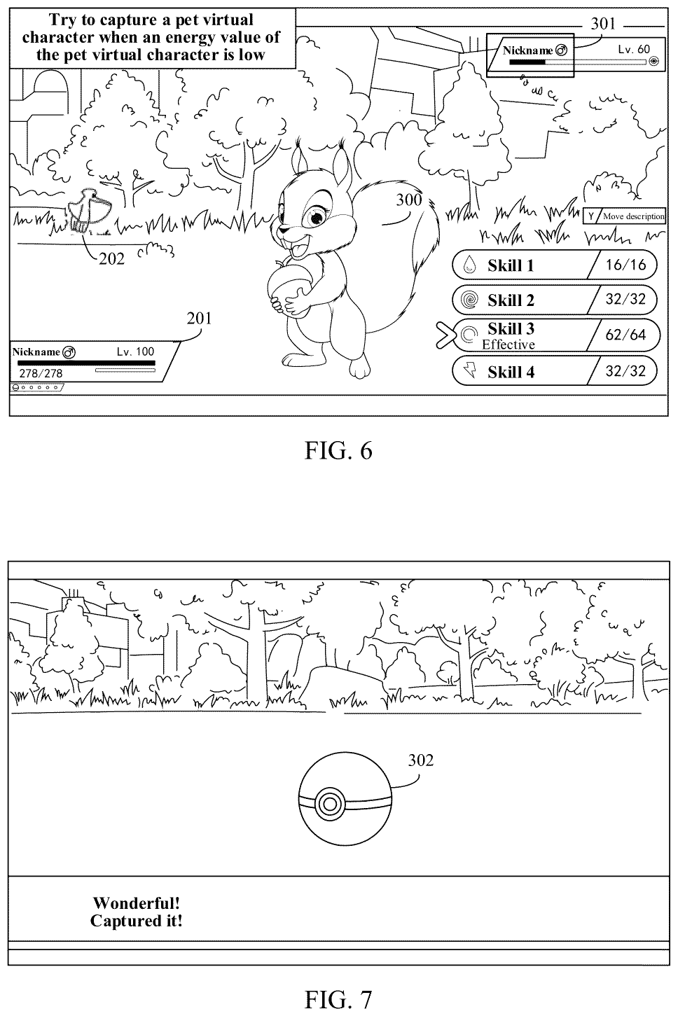

In the related art, FIG. 4, FIG. 5, FIG. 6, and FIG. 7 are schematic diagrams of capturing a pet virtual character of a related art according to some embodiments.

As shown in FIG. 4, a master virtual character 200 of the player in the virtual world is a pet trainer, and the player releases a captured pet virtual character 202 to fight with a to-be-captured pet virtual character 300. A status bar 201 of the pet virtual character 202 may be displayed on the user interface. The status bar 201 displays a nickname, a gender, a level, and an energy value of the pet virtual character 202. The energy value is initially full. A status bar 301 of the pet virtual character 300 is also displayed on the user interface. The status bar 301 displays a nickname, a gender, a level, and an energy value of the pet virtual character 300. The energy value is initially full. It can be learned that, based on the energy value of the pet virtual character 300 being high, there may be little chance of successful capture. As shown in FIG. 5, based on the player attempting to capture the pet virtual character 300, the user interface displays “What a pity! It's just a little bit closer!”, or the capture fails.

As shown in FIG. 6, the master virtual character releases the captured pet virtual character 202 to fight with the to-be-captured pet virtual character 300. A status bar 201 of the pet virtual character 202 may be displayed on the user interface. The status bar 201 displays a nickname, a gender, a level, and an energy value of the pet virtual character 202. The energy value is initially full. A status bar 301 of the pet virtual character 300 is also displayed on the user interface. The status bar 301 displays a nickname, a gender, a level, and an energy value of the pet virtual character 300. The energy value is initially full. The player casts a skill to reduce the energy value of the pet virtual character 300. A probability of successful capture may be relatively high. As shown in FIG. 7, the master virtual character captures the pet virtual character 300 by throwing out an empty spherical container item. If the capture is successful, the pet virtual character 300 is displayed as a spherical container 302.

A capture process may not only be related to the energy value of the pet virtual character 300. However, because the player can only see the energy value of the pet virtual character 300 on the user interface, the player may mistakenly believe that the capture process is to reduce the energy value of the pet virtual character 300. As a result, some players first attack the pet virtual character until the energy value of the pet virtual character 300 reaches a low energy value, and then capture the pet virtual character, which leads to misunderstanding of information.

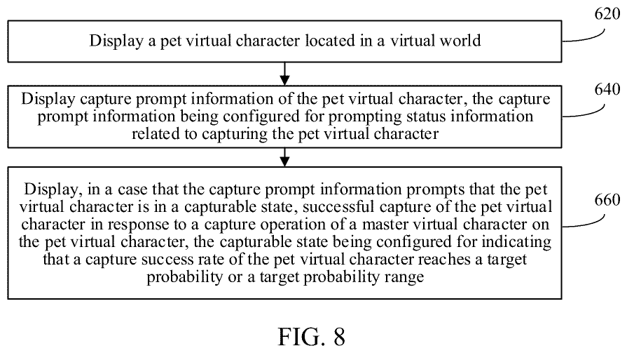

Based on this, FIG. 8 is a flowchart of a virtual world-based capture information display method according to some embodiments. An example in which the method is performed by a client installed on a computer device supporting the virtual world is used for description. The computer device may be the first terminal 120 and/or the second terminal 160 and/or the third terminal 180 and/or the server 140 shown in FIG. 3. The method includes operation 620, operation 640, and operation 660.

Operation 620: Display a pet virtual character located in a virtual world.

In some embodiments, the computer device displays the pet virtual character located in the virtual world. In the non-battle scenario, a to-be-captured pet virtual character may be displayed. In the battle scenario, a pet virtual character released by the master virtual character may be displayed and/or a to-be-captured pet virtual character may be displayed.

In some embodiments, the pet virtual character may be displayed in any possible form. The form of the pet virtual character is related to a level, an environment (weather, time, a plot), an item used, and the like of the pet virtual character. For example, the pet virtual character appears in one of an original form (or referred to as an initial form, a basic form), an evolved form, a dress-up form, and a transformation form, or appears in a form corresponding to an environment at that time, or appears in another form based on the item being used.

In some embodiments, the computer device displays the pet virtual character located in the virtual world based on a combat trigger operation. The combat trigger operation refers to an operation triggered by the player to fight with the to-be-captured pet virtual character to capture the pet virtual character.

In some embodiments, for the to-be-captured pet virtual character, the pet virtual character may be located at any possible position in the virtual world. The position of the pet virtual character may be associated with a type, an attribute, and the like of the pet virtual character. The type of pet virtual character includes at least one of a grass type, a fire type, a water type, and an insect type. For example, the pet virtual character is a grass type character, and is mostly distributed near grasslands, jungles, and the like in the virtual world. The pet virtual character is a water type character, and is mostly distributed near lakes, oceans, and the like in the virtual world. The position of the pet virtual character may be randomly set. For example, the pet virtual character is located near a road in the virtual world.

In some embodiments, the computer device displays the pet virtual character located in the virtual world based on the master virtual character moving to the position of the pet virtual character. Due to a size limitation of the user interface, the content that can be displayed in the user interface is limited, and the pet virtual character may be displayed based on the master virtual character moving near the position of the pet virtual character.

In some embodiments, the player may control the master virtual character to move to the position of the pet virtual character through peripherals such as a handle, a mouse, and a keyboard, or through virtual reality (VR) glasses, a VR helmet, a voice control, a somatosensory operation, and the like.

Operation 640: Display capture prompt information of the pet virtual character, the capture prompt information being configured for prompting status information related to capturing the pet virtual character.

In some embodiments, in the battle scenario or the non-battle scenario, the computer device may display the capture prompt information of the pet virtual character, the capture prompt information being configured for prompting status information related to capturing the pet virtual character. For example, the status information may be status value information of the pet virtual character, or may be information indicating whether the pet virtual character is in the capturable state. In some embodiments, the status information may further be information about an emotional state, a degree to which the pet virtual character likes and dislikes.

In some embodiments, the capture prompt information may be displayed in any position in the virtual world. For example, the capture prompt information may be displayed at one of positions such as upper right, lower right, upper left, or lower left of the virtual world. In some embodiments, the capture prompt information is displayed near the to-be-captured pet virtual character, and a distance between a display position of the capture prompt information and the to-be-captured pet virtual character is less than a threshold.

In some embodiments, the capture prompt information may be displayed in any possible form. For example, the capture prompt information is displayed as one of an annular icon, a spherical container icon, or a bar chart. A display form of the capture prompt information is not limited.

Operation 660: Display successful capture of the pet virtual character based on a capture operation of a master virtual character on the pet virtual character based on the capture prompt information prompting that the pet virtual character is in a capturable state, the capturable state being configured for indicating that a capture success rate of the pet virtual character reaches a target probability or a target probability range.

In some embodiments, based on the capture prompt information prompting that the pet virtual character is in the capturable state, the player may capture the pet virtual character. Based on the pet virtual character being captured, the capture success rate may be relatively high.

In some embodiments, the capturable state is configured for indicating that the capture success rate of the pet virtual character reaches the target probability or the target probability range. The target probability and target probability range may be set based on a technical requirement. For example, the target probability may be set to 95%, and the target probability range is set to 90% to 95%.

In some embodiments, the capture operation on the pet virtual character may be a throwing operation of the spherical container item. For example, the spherical container item may be various types of empty spherical containers, such as an empty ordinary ball, a great ball, and a super heavy ball. The master virtual character captures the pet virtual character by throwing out the empty spherical container item.

In some embodiments, based on the capture prompt information prompting the pet virtual character is in the capturable state, the computer device may display the successful capture of the pet virtual character based on the capture operation of the master virtual character on the pet virtual character. For example, the computer device may display the successfully captured pet virtual character as the spherical container icon, or may display another successfully captured icon, text, and the like.

According to the method provided in some embodiments, by displaying the pet virtual character in the virtual world and the capture prompt information of the pet virtual character, the computer device may visualize information related to the capture of the pet virtual character based on the capture prompt information, and can accurately display whether the pet virtual character is in the capturable state, to avoid misunderstanding of information for the player. Therefore, based on the capture prompt information prompting the pet virtual character is in the capturable state, the player may capture the pet virtual character, which may improve the capture success rate of the pet virtual character and improve efficiency of human-computer interaction.

Some embodiments list two manners of displaying the capture prompt information of the pet virtual character in operation 640. In an application scenario, one of the manners may be implemented or a combination of the two manners may be implemented.

### 1. The First Manner to Display the Capture Prompt Information of the Pet Virtual Character

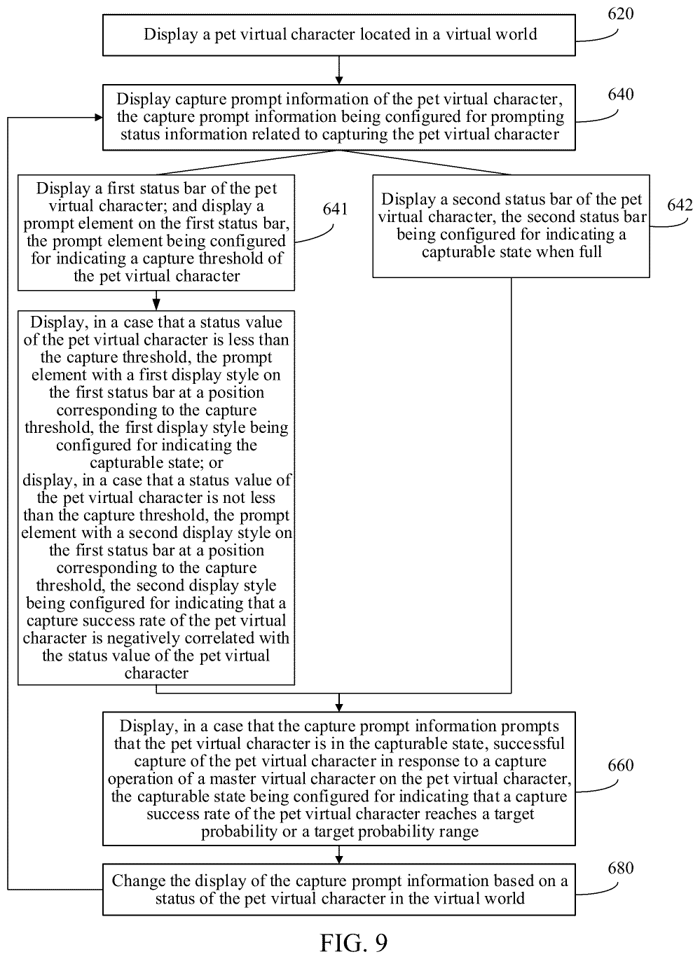

FIG. 9 is a flowchart of a virtual world-based capture information display method according to some embodiments. Operation 640 of displaying the capture prompt information of the pet virtual character includes operation 641:

Operation 641: Display a first status bar of the pet virtual character; and display a prompt element on the first status bar, the prompt element being configured for indicating a capture threshold of the pet virtual character.

For example, the status bar is configured for indicating status information of the pet virtual character. The status information of the pet virtual character may be a status value of the pet virtual character, or may be whether the pet virtual character is in the capturable state. In some embodiments, the status value includes an energy value or a health point.

In some embodiments, based on the status information of the pet virtual character being the status value, the status bar may be configured for displaying the status value of the pet virtual character, and the status bar may also be referred to as the first status bar. In an initial status in which the pet virtual character is not captured, the first status bar is full. In some embodiments, the computer device displays the first status bar of the pet virtual character.

For example, the capture threshold is an explicit prompt of a corresponding upper limit of the status value based on the capture success rate of the pet virtual character reaching a target condition or the target probability range. Based on a status value being less than or equal to the capture threshold, the capture success rate of the pet virtual character may reach the target condition or the target probability range; or based on a status value being greater than the capture threshold, the capture success rate of the pet virtual character may not reach the target condition or the target probability range.

In some embodiments, based on the status value being greater than the capture threshold, a difference between the status value and the capture threshold may be negatively correlated with the capture success rate. A grater difference indicates that the capture success rate is lower. As the difference between the status value and the capture threshold increases, the capture success rate of the pet virtual character gradually approaches a fixed capture success rate, and the fixed capture success rate is greater than 0.

For example, the capture threshold of the pet virtual character corresponds to the pet virtual character, and the capture threshold may be fixed.

In some embodiments, the capture threshold is a dynamically changing value. The capture threshold is related to at least one of the following factors:
a pet type and/or a pet level of the pet virtual character;
an item type and/or an item level of a spherical container item used in the capture operation;
a number of historical capture times of the pet virtual character by the master virtual character;
the number of historical capture times of the pet virtual character in the same type by the master virtual character;
whether the pet virtual character discovers the master virtual character;
a distance between the master virtual character and the pet virtual character;
a personality matching degree between the master virtual character and the pet virtual character;
a gender matching degree between the master virtual character and the pet virtual character;
weather in the virtual world;
a plot in which the pet virtual character is located in the virtual world;
an interactive operation between the master virtual character and the pet virtual character;
whether the pet virtual character discovers the master virtual character; and the distance between the master virtual character and the pet virtual character.

For example, based on the status value of a pet virtual character being full, or 100, a corresponding capture success rate may be 30%. When a status value of the pet virtual character is 25, the capture success rate reaches a target probability of 95%, and the capture threshold is 25. The capture threshold is configured for prompting that the status value corresponding to the capture success rate reaching the target probability of 95% is 25. When the personality of the pet virtual character is timid and not bellicose, and the master virtual character attacks the pet virtual character, the capture threshold is reduced. For example, the capture success rate may reach the target probability of 95% based on the status value of the pet virtual character being 15.

For another example, a pet virtual character may have an environment that the pet virtual character likes or dislikes. When the pet virtual character likes the environment, an affinity effect may be obtained, and the corresponding capture threshold may be increased. On the contrary, based on the pet virtual character disliking the environment, a conflict effect may exist, and the corresponding capture threshold may be reduced.

In some embodiments, the computer device displays a prompt element on the first status bar, and the prompt element is configured for indicating the capture threshold of the pet virtual character. The first status bar may display the status value of the pet virtual character and the capture threshold of the pet virtual character.

In some embodiments, that the computer device displays the prompt element on the first status bar includes: displaying the prompt element on the first status bar at a position corresponding to the capture threshold, and a display style of the prompt element is at least one of a vertical bar, a pointer, and an icon.

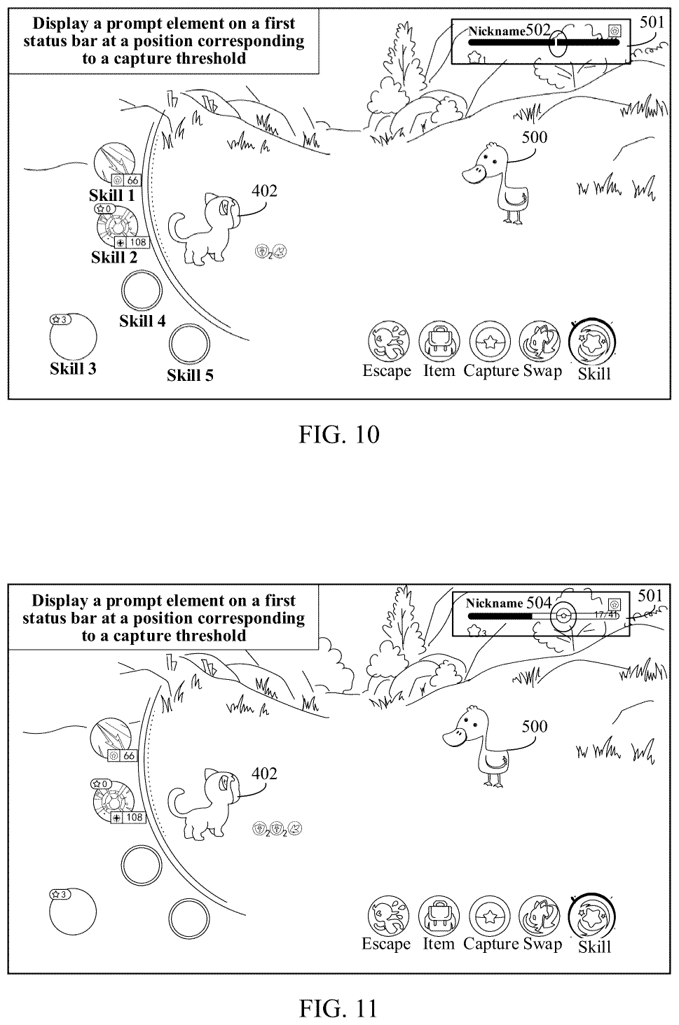

For example, as shown in FIG. 10, the first status bar is a bar chart. In a battle scenario between the pet virtual character 402 released by the master virtual character and the to-be-captured pet virtual character 500, a prompt element 502 is displayed on the first status bar 501. The prompt element 502 is configured for indicating the capture threshold of the pet virtual character 500, and the display style of the prompt element 502 is a vertical bar.

In some embodiments, the prompt element is displayed on the first status bar, and the prompt element is configured for indicating the capture threshold of the pet virtual character, so that the capture threshold of the pet virtual character can be visualized through the prompt element, and a success rate of capturing the pet virtual character may be improved.

In an example, that the computer device displays the prompt element on the first status bar at a position corresponding to the capture threshold includes:
based on a status value of the pet virtual character being less than the capture threshold, displaying the prompt element with a first display style on the first status bar at a position corresponding to the capture threshold, the first display style being configured for indicating the capturable state; or
based on a status value of the pet virtual character being not less than the capture threshold, displaying the prompt element with a second display style on the first status bar at a position corresponding to the capture threshold, the second display style being configured for indicating that the capture success rate of the pet virtual character is negatively correlated with the status value of the pet virtual character.

In some embodiments, the status value of the pet virtual character may be an energy value or a health point. When the status value of the pet virtual character is less than the capture threshold, the capture success rate of the pet virtual character reaches the target probability or the target probability range, or the pet virtual character is in the capturable state. The prompt element with the first display style may be displayed on the first status bar and at the position corresponding to the capture threshold, and the first display style is configured for indicating the capturable state.

In some embodiments, based on the status value being less than the capture threshold, the pet virtual character may be in the capturable state. The capture success rate may also be directly set to the fixed capture success rate, for example, the fixed capture success rate may be set to 95%.

For example, as shown in FIG. 11, based on the status value of the pet virtual character 500 being less than the capture threshold, a prompt element 504 with a first display style may be displayed on the first status bar 501 and at a position corresponding to the capture threshold. The prompt element 504 with the first display style may be a spherical container icon, and may be configured for indicating the capturable state.

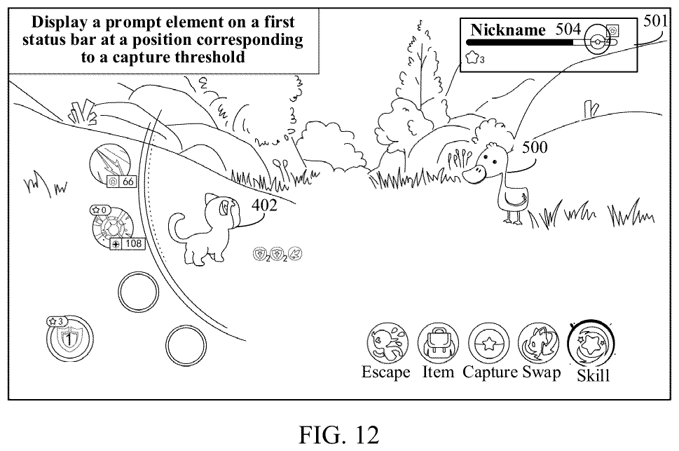

In some embodiments, based on the pet virtual character being in a high status value or a low status value, there may be a situation in which the status value of the pet virtual character is less than the capture threshold. For example, as shown in FIG. 12, based on the pet virtual character 500 being in a high status value and the status value of the pet virtual character 500 being less than the capture threshold, the prompt element 504 with the first display style may be displayed on the first status bar 501 at a position corresponding to the capture threshold. The prompt element 504 with the first display style is a spherical container icon, and is configured for indicating the capturable state. The pet virtual character may have the capturable state based on being in the high status value, and there may be no need to first attack the pet virtual character to being in the low status value.

In some embodiments, based on the status value of the pet virtual character being not less than (greater than or equal to) the capture threshold, the capture success rate of the pet virtual character may not reach the target probability or the target probability range, or the pet virtual character is not in the capturable state. The computer device may display a prompt element with a second display style on the first status bar at a position corresponding to the capture threshold. The first display style may be different from the second display style. In some embodiments, the prompt element with the second display style is a vertical bar.

In some embodiments, the second display style is configured for indicating that the capture success rate of the pet virtual character is negatively correlated with the status value of the pet virtual character. A higher status value of the pet virtual character may indicate the capture success rate is lower; and a lower status value of the pet virtual character may indicate the capture success rate is higher.

In some embodiments, based on the status value of the pet virtual character being not less than the capture threshold, as the status value reduces, the capture success rate of the pet virtual character may gradually approach the fixed capture success rate.

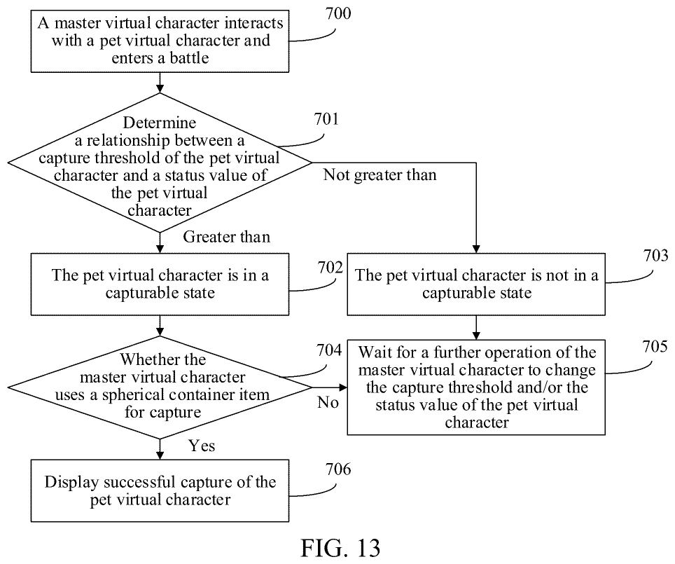

As an example, FIG. 13 is a flowchart of a virtual world-based capture information display method according to some embodiments. A manner of determining whether the pet virtual character is in the capturable state is as follows:

Operation 700: The master virtual character interacts with the pet virtual character and enters a battle.

Operation 701: Determine a relationship between the capture threshold of the pet virtual character and the status value of the pet virtual character. When the capture threshold of the pet virtual character is greater than the status value of the pet virtual character, enter operation 702; and based on the capture threshold of the pet virtual character being not greater than the status value of the pet virtual character, enter operation 703.

Operation 702: Determine that the pet virtual character is in the capturable state, and enter operation 704.

Operation 703: Determine that the pet virtual character is not in the capturable state, and enter operation 705.

Operation 704: Determine whether the master virtual character uses a spherical container item (for example, a Poke Ball) to capture. If yes, enter operation 706; and if not, enter operation 705.

Operation 705: Wait for a further operation of the master virtual character to change the capture threshold and/or the status value of the pet virtual character. Then, re-enter operation 701 to determine the relationship between the capture threshold of the pet virtual character and the status value of the pet virtual character.

Operation 706: Display successful capture of the pet virtual character.

In some embodiments, based on the relationship between the status value of the pet virtual character and the capture threshold of the pet virtual character, it is determined whether the pet virtual character is in the capturable state, and the prompt element of the display style corresponding to whether the pet virtual character is in the capturable state is displayed. In this way, the capturable state of the pet virtual character can be accurately displayed, and the player may not need to reduce the pet virtual character to a low status value before capturing the pet virtual character.

### 2. The Second Manner to Display the Capture Prompt Information of the Pet Virtual Character

In some embodiments, referring to FIG. 9, operation 640 of displaying the capture prompt information of the pet virtual character includes operation 642.

Operation 642: Display a second status bar of the pet virtual character, the second status bar being configured for indicating the capturable state when full.

For example, based on the status information of the pet virtual character being whether the pet virtual character is in the capturable state, the status bar may be configured for displaying whether the pet virtual character is in the capturable state, and the status bar may also be referred to as the second status bar.

In some embodiments, the computer device displays the second status bar of the pet virtual character, and the second status bar is configured for indicating the capturable state when full. When the pet virtual character is in the capturable state, the second status bar is full. The second status bar may also be understood as representing a degree of satisfaction. When the master virtual character attacks the pet virtual character, the degree of satisfaction is consumed. When the degree of satisfaction is full, the pet virtual character is in the capturable state. In some embodiments, the master virtual character may improve the degree of satisfaction of the pet virtual character through friendly operations such as friendly items used and fruit feeding.

In some embodiments, the computer device can visualize the capturable state of the pet virtual character by displaying the second status bar of the pet virtual character to indicate the capturable state. The capturable state can be indicated based on the pet virtual character being in the high status value or the low status value. The player may improve the capture success rate by capturing the pet virtual character based on the capturable state.

In an example, the pet virtual character corresponds to an initial value of the capture threshold. In some embodiments, the initial value of the capture threshold is related to a first factor, and the first factor includes at least one of the following factors:
a pet type and/or a pet level of the pet virtual character;
an item type and/or an item level of a spherical container item used in the capture operation;
a number of historical capture times of the pet virtual character by the master virtual character;
the number of historical capture times of the pet virtual character in the same type by the master virtual character;
whether the pet virtual character discovers the master virtual character;
a distance between the master virtual character and the pet virtual character;
a personality matching degree between the master virtual character and the pet virtual character; and
a gender matching degree between the master virtual character and the pet virtual character.

In some embodiments, the pet type of the pet virtual character includes but is not limited to birds, insects, large animals, small animals, and the like, the pet level includes but is not limited to junior, intermediate, senior, and the like, and the initial value of the capture threshold of the pet virtual character is related to the pet type and/or the pet level of the pet virtual character. A rarer pet type and/or a higher pet level indicate that the pet virtual character is less likely to be captured, and a corresponding initial value of the capture threshold is smaller.

In some embodiments, the item type of the spherical container item includes but is not limited to an ordinary item, an intermediate item, an advanced item, and the like, and the item level includes but is not limited to junior, intermediate, senior, and the like. A higher item type and/or a higher item level of the spherical container item used in the capture operation indicate that the pet virtual character is more likely to be captured, and a corresponding initial value of the capture threshold is large.

In some embodiments, the initial value of the capture threshold is related to the number of historical capture times of the pet virtual character by the master virtual character. The number of historical capture times of the pet virtual character by the master virtual character may be in a positive correlation with the initial value of the capture threshold. For example, a greater number of historical capture times indicates that the pet virtual character is more likely to be captured by the master virtual character, and a corresponding initial value of the capture threshold is larger.

In some embodiments, the initial value of the capture threshold is related to the number of historical capture times of the same type of pet virtual characters by the master virtual character. The number of historical capture times of the same type of pet virtual characters by the master virtual character may be in a positive correlation with the initial value of the capture threshold. For example, a greater number of historical capture times of the same type of pet virtual characters represents that the master virtual character is better at capturing this type of the pet virtual character, or the initial value of the capture threshold corresponding to this type of the pet virtual character is larger.

In some embodiments, the initial value of the capture threshold is also related to whether the pet virtual character discovers the master virtual character. When the pet virtual character does not discover the master virtual character, the master virtual character may go around a blind region of the pet virtual character and capture the pet virtual character directly. The master virtual character may only need to use a capture strategy, and there may be no need to fight to increase the capture success rate. For example, based on the pet virtual character not discovering the master virtual character, a corresponding initial value of the capture threshold may be larger.

In some embodiments, the distance between the master virtual character and the pet virtual character may affect the capture threshold, and the distance is in a positive correlation with the initial value of the capture threshold. For example, a closer distance between the master virtual character and the pet virtual character indicates that the skill casted by the master virtual character is more accurate. The capture success rate of the pet virtual character may be higher, or a corresponding initial value of the capture threshold may be greater.

In some embodiments, the initial value of the capture threshold is also related to the personality matching degree between the master virtual character and the pet virtual character. The personality matching degree may be in a positive correlation with the initial value of the capture threshold. Based on a personality attribute of the pet virtual character, a pet virtual character may have the personality of the master virtual character that the pet virtual character likes or dislikes. For example, a pet virtual character with a bellicose personality may prefer a master virtual character with a bellicose personality, and the two have a relatively high personality matching degree. A higher personality matching degree between the master virtual character and the pet virtual character indicates that the pet virtual character is more likely to be captured, or the initial value of the capture threshold is greater.

In some embodiments, the initial value of the capture threshold is also related to the gender matching degree between the master virtual character and the pet virtual character. The gender matching degree may be in a positive correlation with the initial value of the capture threshold. Based on a gender attribute of the pet virtual character, a pet virtual character may have the gender of the master virtual character that the pet virtual character likes. A higher gender matching degree between the master virtual character and the pet virtual character indicates that the pet virtual character is more likely to be captured, or the initial value of the capture threshold is greater.

A numerical value of the foregoing capture threshold is a relative value, and the numerical value may need to be determined based on a situation. The initial value of the capture threshold of the pet virtual character is related to the first factor. However, for a first factor, whether the initial value of the capture threshold of the pet virtual character caused by the first factor is large or small may need to be set based on the pet virtual character.

For example, the first factor is the item type of the spherical container item. When a pet virtual character uses a more advanced spherical container item, the capture success rate is higher, or the corresponding initial value of the capture threshold is larger. When another pet virtual character uses a more advanced spherical container item, the capture success rate is smaller, or the corresponding initial value of the capture threshold is small, or whether the initial value of the capture threshold of the pet virtual character caused by the first factor is large or small may need to be set according to the pet virtual character.

In some embodiments, there is an initial value for the capture threshold of the pet virtual character, and the initial value of the capture threshold is related to the foregoing first factor, so that the initial value of the capture threshold of the pet virtual character can be adaptively adjusted with reference to information such as the operation or the attribute of the master virtual character, which greatly enriches the capture scenario of the pet virtual character. Further, different master virtual characters may also adaptively use different capture strategies based on the initial value of the capture threshold of the pet virtual character, which may improve efficiency of human-computer interaction and improve a gaming experience of the player.

In some embodiments, the capture prompt information displayed by the computer device may be changed. In some embodiments, in an example, referring to FIG. 9, the method further includes operation 680.

Operation 680: Change the display of the capture prompt information based on a status of the pet virtual character in the virtual world.

In some embodiments, the status of the pet virtual character in the virtual world is related to factors such as position, form, level, status value, environment, and weather of the pet virtual character. The status of the pet virtual character in the virtual world may affect the display of the capture prompt information. For example, for the same pet virtual character, based on the weather raining, the capture prompt information may be displayed as a vertical bar, and based on the weather being sunny, the capture prompt information may be displayed as an icon. In some embodiments, the computer device changes the display of the capture prompt information based on the status of the pet virtual character in the virtual world.

In some embodiments, the display of the capture prompt information is changed based on the status of the pet virtual character in the virtual world, and the capture prompt information may be combined with the virtual world. In this way, a turn-based battle process is organically integrated into the virtual world. It is no longer two torn parts, but forms a whole.

In some embodiments, the capture prompt information is represented by the capture threshold. The operation 680 of changing the display of the capture prompt information based on a status of the pet virtual character in the virtual world includes:

Based on a second factor causing the capture threshold to change, a display position of the prompt element may be changed on the first status bar.

In some embodiments, in the battle scenario or the non-battle scenario, the capture threshold of the pet virtual character may also be changed based on the second factor, or the second factor causes the capture threshold to change.

In some embodiments, the second factor includes at least one of the following factors:
weather in the virtual world;
a plot in which the pet virtual character is located in the virtual world;
an interactive operation between the master virtual character and the pet virtual character;
whether the pet virtual character discovers the master virtual character; and
a distance between the master virtual character and the pet virtual character.

In some embodiments, the second factor may be the weather in the virtual world. For example, if the pet virtual character likes a sunny day and dislikes a rainy day, the capture threshold of the pet virtual character in sunny weather is larger. When the weather changes from the sunny day to the rainy day, the capture threshold of the pet virtual character becomes smaller.

In some embodiments, the second factor may be a plot in which the pet virtual character is located in the virtual world. For example, based on the pet virtual character preferring an environment of a current plot, a corresponding capture threshold may be larger. When the pet virtual character moves to another plot, the capture threshold of the pet virtual character becomes smaller.

In some embodiments, the second factor may be an interactive operation between the master virtual character and the pet virtual character. For example, based on the pet virtual character liking the interactive operation, the capture threshold of the pet virtual character may increase. Based on the pet virtual character disliking the interactive operation, the capture threshold of the pet virtual character may reduce.

In some embodiments, the second factor further includes whether the pet virtual character discovers the master virtual character. When the pet virtual character does not discover the master virtual character, the pet virtual character is relatively easier to be captured, and the capture threshold is higher.

In some embodiments, the second factor may further be a distance between the master virtual character and the pet virtual character. A closer distance between the master virtual character and the pet virtual character indicates that the skill casted by the master virtual character is more accurate. The capture success rate of the pet virtual character may be higher, or a corresponding initial value of the capture threshold may be greater. As the distance shortens, the capture threshold may increase.

In some embodiments, the interactive operation between the master virtual character and the pet virtual character includes at least one of the following:
the master virtual character engages in a turn-based battle with the pet virtual character;
the master virtual character feeds the pet virtual character;
the master virtual character heals the pet virtual character;
the master virtual character changes the weather in the virtual world by using a captured pet virtual character and/or an item; and
the master virtual character changes the plot in which the pet virtual character is located in the virtual world by using the captured pet virtual character and/or the item.

In some embodiments, the interactive operation between the master virtual character and the pet virtual character includes a turn-based battle between the master virtual character and the pet virtual character. Some pet virtual characters have bellicose personalities. When the master virtual character engages in the turn-based battle with the pet virtual character, the capture thresholds of these pet virtual characters change.

In some embodiments, the interactive operation between the master virtual character and the pet virtual character includes that the master virtual character feeds the pet virtual character. When the pet virtual character likes food, the capture threshold increases. Conversely, based on the pet virtual character disliking the food, the capture threshold may reduce.

In some embodiments, the interactive operation further includes the master virtual character heals the pet virtual character. When the master virtual character heals the pet virtual character, the favorability of the pet virtual character toward the master virtual character increases, and the capture success rate increases, or the capture threshold increases.

In some embodiments, the interactive operation further includes that the master virtual character changes the weather in the virtual world through a captured pet virtual character and/or an item. When the pet virtual character likes the changed weather, the pet virtual character is easier to be captured, and the capture threshold increases accordingly.

In some embodiments, the interactive operation further includes that the master virtual character changes the plot in which the pet virtual character is located in the virtual world through the captured pet virtual character and/or the item. When the pet virtual character likes an environment of the changed plot, the pet virtual character is easier to be captured, or the capture threshold increases.

In some embodiments, the degree to which the pet virtual character likes and dislikes the second factor are determined based on the foregoing second factor, and the capture threshold is adjusted based on the degree to which the pet virtual character likes and dislikes. For example, based on the pet virtual character liking the second factor, the capture threshold may increase, based on the pet virtual character disliking the factor, the capture threshold may reduce, and based on the pet virtual character being indifferent to the factor, the capture threshold may remain unchanged.

In some embodiments, based on the second factor causing the capture threshold to change, the display position of the prompt element may be changed on the first status bar. During the change of the display position of the prompt element on the first status bar, combined with whether the capture threshold increases or reduces, it is determined that the prompt element is displayed in the first display style or the second display style during the change, and based on the change of the display position of the prompt element on the first status bar ending, combined with whether the pet virtual character is in the capturable state, the prompt element may be displayed in the first display style or the second display style based on the change ending.

In some embodiments, during the change of the display position of the prompt element on the first status bar, based on the capture threshold increasing, the prompt element may be displayed in the first display style during the change, and based on the capture threshold reducing, the prompt element may be displayed in the second display style.

In some embodiments, based on the change of the display position of the prompt element on the first status bar ending, based on the pet virtual character being in the capturable state, the prompt element may be displayed in the first display style, and based on the pet virtual character being not in the capturable state, the prompt element may be displayed in the second display style.

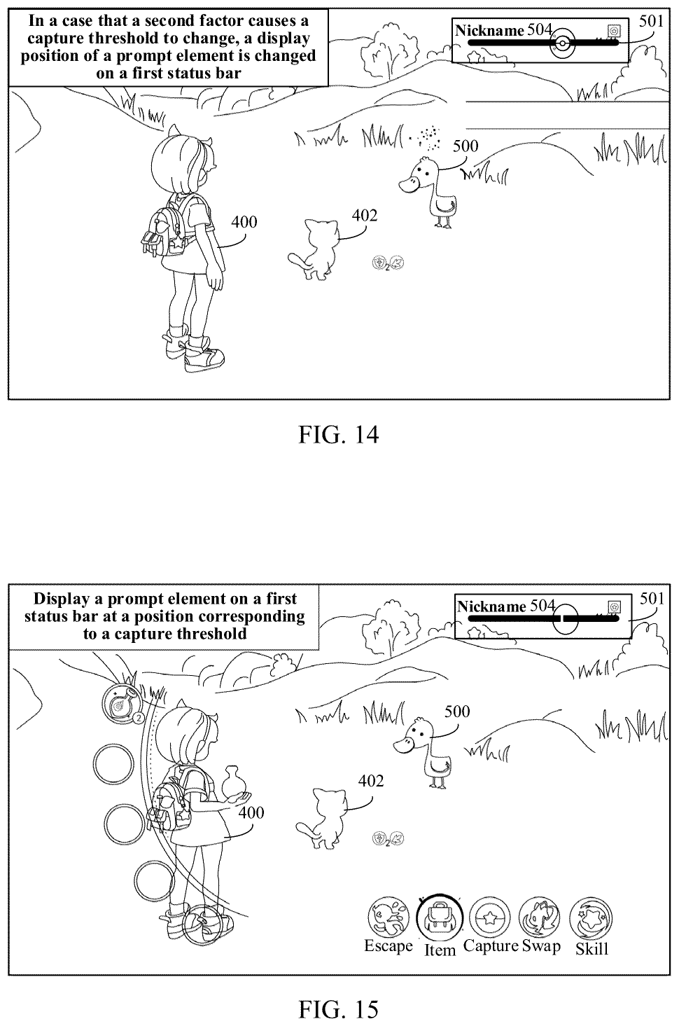

For example, as shown in FIG. 14 and FIG. 15, in the battle scenario between the pet virtual character 402 released by the master virtual character 400 and the to-be-captured pet virtual character 500, based on the interactive operation between the master virtual character 400 and the pet virtual character 500 causing the capture threshold of the pet virtual character 500 to change, for example, the interactive operation may use a friendly item, and the capture threshold may increase. In this way, the prompt element 504 on the first status bar 501 moves to the right in the first display style (a spherical container icon). After a position movement of the prompt element 504 on the first status bar is completed, and based on the pet virtual character 500 being not in the capturable state, the prompt element 504 may be displayed in the second display style (a vertical bar).

In some embodiments, based on the second factor causing the capture threshold to change, a changed capture threshold may be determined. When the changed capture threshold reaches a stage value, the pet virtual character may be triggered to cast a friendly skill; and based on the changed capture threshold not reaching the stage value, the pet virtual character may be triggered to adjust a skill intensity.

In some embodiments, based on the changed capture threshold reaching the stage value, it may represent that the pet virtual character obtains varying degrees of satisfaction. The pet virtual character does not attack this round and instead cast the friendly skill. For example, based on the changed capture threshold reaching more than 80 points, the pet virtual character may begin to perform singing, and based on the changed capture threshold reaching more than 90 points, the pet virtual character may not only begins to perform singing, but may also actively replenish the status value (regenerates health) of the master virtual character or the pet virtual character released by the master virtual character.

In some embodiments, based on the changed capture threshold not reaching the stage value, the pet virtual character may be triggered to produce an emotional reaction. Based on the capture threshold increasing, a temper of the pet virtual character may improve, and the pet virtual character may be triggered to reduce the skill intensity, or to cast a low-damage or gain-effect skill. Based on the capture threshold reducing, the temper of the pet virtual character may decline, and the pet virtual character may be triggered to increase the skill intensity, or to cast a high-damage or debuff effect skill.

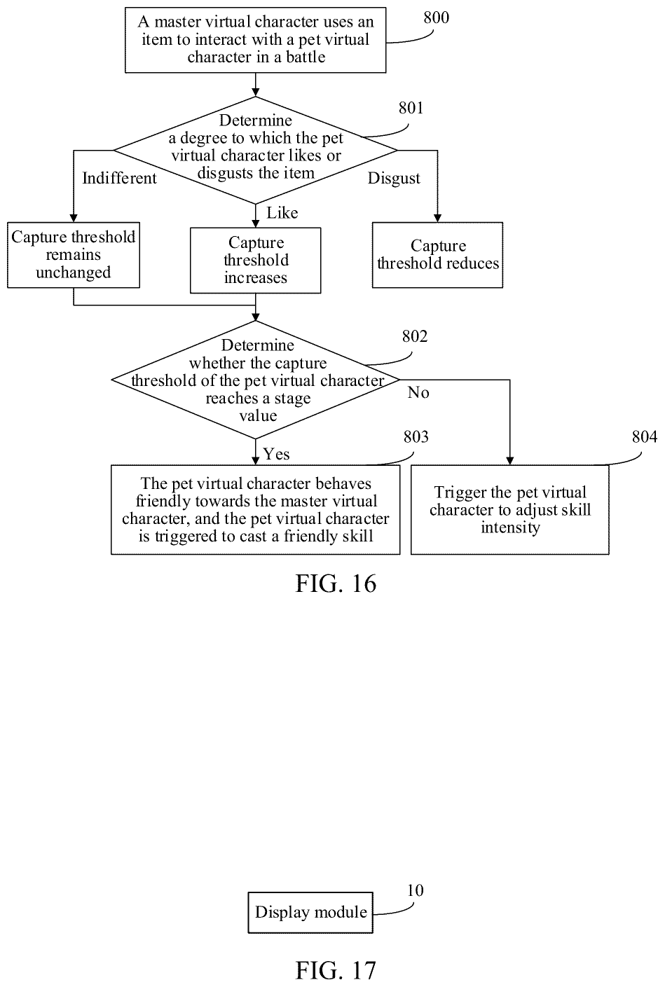

As an example, FIG. 16 is a flowchart of a virtual world-based capture information display method according to some embodiments. The sequence of operations based on at least one factor causing the capture threshold to change is as follows:

Operation 800: The master virtual character uses an item to interact with the pet virtual character during combat.

Operation 801: Determine a degree to which the pet virtual character likes or dislikes the item. When the pet virtual character likes the item, the capture threshold of the pet virtual character increases, based on the pet virtual character disliking the item, the capture threshold of the pet virtual character may reduce, and based on the pet virtual character being indifferent to the item, the capture threshold of the pet virtual character may remain unchanged.

Operation 802: Determine whether the capture threshold of the pet virtual character reaches the stage value. If yes, enter operation 803; and if not, enter operation 804.

Operation 803: The pet virtual character behaves friendly to the master virtual character, to trigger the pet virtual character to cast the friendly skill. For example, the pet virtual character performs singing, or the master virtual character and/or the pet virtual character released by the master virtual character replenishes the status value.

Operation 804: Trigger the pet virtual character to adjust the skill intensity. When the capture threshold increases, the pet virtual character reduces the skill intensity, and based on the capture threshold reducing, the pet virtual character may improve the skill intensity.

In some embodiments, the capture threshold of the pet virtual character may be changed through the second factor, so that the capture threshold of the pet virtual character can be adaptively adjusted with reference to information such as the virtual world and the operation of the master virtual character, which greatly enriches a capture scenario of the pet virtual character. Based on the second factor causing the capture threshold to change, the changed capture threshold may be visualized by changing the display position of the prompt element on the first status bar. Further, different master virtual characters may also adjust the capture strategy at any time based on the changed capture threshold of the pet virtual character, which may improve efficiency of human-computer interaction and improve a gaming experience of the player.

FIG. 17 is a structural block diagram of a virtual world-based capture information display apparatus according to some embodiments. The apparatus includes:
a display module 10, configured to display a pet virtual character located in the virtual world,
the display module 10 being configured to display capture prompt information of the pet virtual character, the capture prompt information being configured for prompting status information related to capturing the pet virtual character; and
the display module 10 being configured to display, based on the capture prompt information prompting the pet virtual character is in a capturable state, successful capture of the pet virtual character based on a capture operation of a master virtual character on the pet virtual character,
the capturable state being configured for indicating that a capture success rate of the pet virtual character reaches a target probability or a target probability range.

In some embodiments, the display module 10 may be configured to: display a first status bar of the pet virtual character; and display a prompt element on the first status bar, the prompt element being configured for indicating a capture threshold of the pet virtual character.

In some embodiments, the display module 10 may be configured to display the prompt element on the first status bar at a position corresponding to the capture threshold, and a display style of the prompt element is at least one of a vertical bar, a pointer, and an icon.

In some embodiments, the display module 10 may be configured to display, based on a status value of the pet virtual character being less than the capture threshold, the prompt element with a first display style on the first status bar at a position corresponding to the capture threshold, the first display style being configured for indicating the capturable state; or the display module 10 may be configured to display, based on a status value of the pet virtual character being not less than the capture threshold, the prompt element with a second display style on the first status bar at a position corresponding to the capture threshold, the second display style being configured for indicating that the capture success rate of the pet virtual character is negatively correlated with the status value of the pet virtual character.

In some embodiments, the display module 10 may be configured to display a second status bar of the pet virtual character, the second status bar being configured for indicating the capturable state when full.

In some embodiments, an initial value of the capture threshold is related to a first factor, the first factor including at least one of the following factors:
a pet type and/or a pet level of the pet virtual character;
an item type and/or an item level of a spherical container item used in the capture operation;
a number of historical capture times of the pet virtual character by the master virtual character;
the number of historical capture times of the pet virtual character in the same type by the master virtual character;
whether the pet virtual character discovers the master virtual character;
a distance between the master virtual character and the pet virtual character;
a personality matching degree between the master virtual character and the pet virtual character; and
a gender matching degree between the master virtual character and the pet virtual character.

In some embodiments, the display module 10 may be configured to change the display of the capture prompt information based on a status of the pet virtual character in the virtual world.

In some embodiments, the display module 10 may be configured to change, based on a second factor causing the capture threshold to change, a display position of the prompt element on the first status bar,
the second factor including at least one of the following factors:
weather in the virtual world;
a plot in which the pet virtual character is located in the virtual world;
an interactive operation between the master virtual character and the pet virtual character;
whether the pet virtual character discovers the master virtual character; and
a distance between the master virtual character and the pet virtual character.

In some embodiments, the interactive operation between the master virtual character and the pet virtual character includes at least one of the following:
the master virtual character engages in a turn-based battle with the pet virtual character;
the master virtual character feeds the pet virtual character;
the master virtual character heals the pet virtual character;
the master virtual character changes the weather in the virtual world by using a captured pet virtual character and/or an item; and
the master virtual character changes the plot in which the pet virtual character is located in the virtual world by using the captured pet virtual character and/or the item.

According to some embodiments, each module in the apparatus may exist respectively or be combined into one or more units. Some units may be further split into multiple smaller function subunits, thereby implementing the same operations without affecting the technical effects of some embodiments. The modules are divided based on logical functions. In application, a function of one module may be realized by multiple units, or functions of multiple modules may be realized by one unit. In some embodiments, the apparatus may further include other units. In application, these functions may also be realized cooperatively by the other units, and may be realized cooperatively by multiple units.

A person skilled in the art would understand that these “modules” and “units” could be implemented by hardware logic, a processor or processors executing computer software code, or a combination of both. The “modules” and “units” may also be implemented in software stored in a memory of a computer or a non-transitory computer-readable medium, where the instructions of each module and unit are executable by a processor to thereby cause the processor to perform the respective operations of the corresponding module and unit.

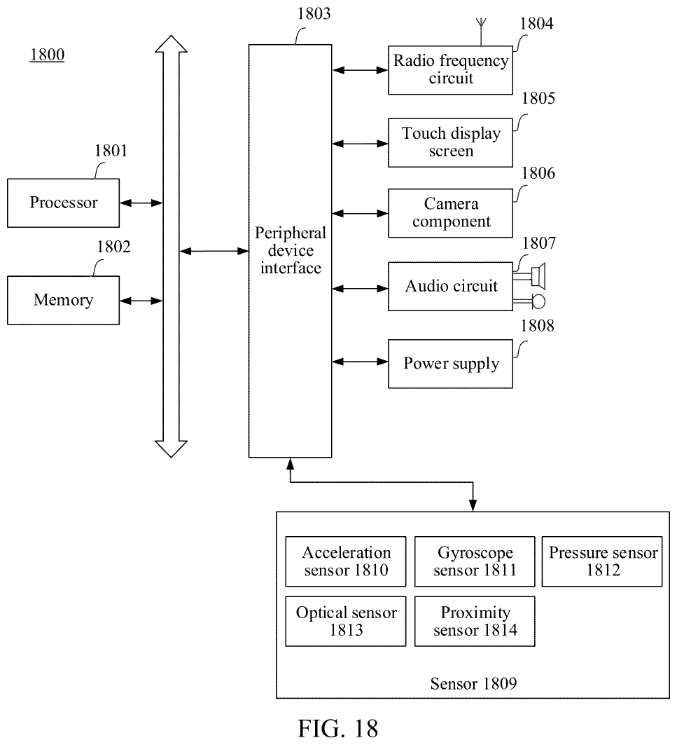

FIG. 18 is a structural block diagram of a computer device 1800 according to some embodiments. The computer device 1800 may be a portable mobile terminal, such as: a smartphone, a tablet computer, a Moving Picture Experts Group Audio Layer III (MP3) player, and a Moving Picture Experts Group Audio Layer IV (MP4) player. The computer device 1800 may be further referred to as another name such as user equipment or a portable terminal.

Usually, the computer device 1800 includes: a processor 1801 and a memory 1802.

The processor 1801 may include one or more processing cores, such as a 4-core processor or an 8-core processor. The processor 1801 may be implemented by using at least one hardware form of a digital signal processor (DSP), a field programmable gate array (FPGA), and a programmable logic array (PLA). The processor 1801 may further include a main processor and a coprocessor. The main processor is a processor configured to process data in an active state, also referred to as a central processing unit (CPU). The coprocessor is a low-power consumption processor configured to process data in a standby state. In some embodiments, the processor 1801 may be integrated with a graphics processing unit (GPU). The GPU may be configured to be responsible for rendering and drawing content that may need to be displayed in a display. In some embodiments, the processor 1801 may also include an artificial intelligence (AI) processor. The AI processor may be configured to process a computing operation related to machine learning.

The memory 1802 may include one or more computer-readable storage media. The computer-readable storage medium may be tangible and non-transitory. The memory 1802 may further include a high-speed random access memory and a non-volatile memory, for example, one or more disk storage devices and flash storage devices. In some embodiments, the non-transitory computer-readable storage medium in the memory 1802 may be configured to store at least one instruction, and the at least one instruction being configured to be executed by the processor 1801 to implement a virtual world-based capture information display method.

In some embodiments, the computer device 1800 may further include: a peripheral device interface 1803 and at least one peripheral device. Specifically, the peripheral device includes: at least one of a radio frequency circuit 1804, a touch display screen 1805, a camera 1806, an audio circuit 1807, and a power supply 1808.

In some embodiments, the computer device 1800 further includes one or more sensors 1809. The one or more sensors 1809 include but are not limited to: an acceleration sensor 1810, a gyroscope sensor 1811, a pressure sensor 1812, an optical sensor 1813, and a proximity sensor 1814.

A person skilled in the art may understand that the structure shown in FIG. 18 does not constitute any limitation on the computer device 1800, and the computer device 1800 may include more components or fewer components than those shown in the figure, or some components may be combined, or a different component deployment may be used.

According to some embodiments, provided is a computer-readable storage medium, having a computer program stored therein, at least one instruction, at least one program, a code set or an instruction set, the computer program, the at least one instruction, the at least one program, the code set or the instruction set being loaded and executed by a processor to implement the virtual world-based capture information display method according to some embodiments.

According to some embodiments, provided is a computer program product or a computer program. The computer program product or the computer program includes computer instructions, and the computer instructions are stored in a computer-readable storage medium. A processor of a computer device reads the computer instructions from the computer-readable storage medium, and executes the computer instructions, to cause the computer device to perform the virtual world-based capture information display method according to some embodiments.

The sequence numbers according to some embodiments are merely for description purpose, and do not indicate any preference.

A person of ordinary skill in the art may understand that all or some of the operations of the foregoing embodiments may be implemented by using hardware, or may be implemented by a program instructing relevant hardware. The program may be stored in a computer-readable storage medium. The storage medium may be a ROM, a magnetic disk, an optical disc, or the like.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A method for displaying capture information in a virtual world, performed by a computer device, the method comprising:
displaying a pet virtual character within a virtual world;
displaying a status bar corresponding to status information of the pet virtual character, the status information comprising a status value corresponding to at least one of an energy value or health points;
determining a capture threshold for the pet virtual character;
displaying a prompt element on the status bar at a position corresponding to the capture threshold;
receiving a capture operation performed by a master virtual character on the pet virtual character; and
displaying capture success in response to the capture operation when the pet virtual character is in a capturable state, wherein the pet virtual character is in the capturable state when the status value is less than the capture threshold.

2. The method according to claim 1, wherein the prompt element is displayed in (i) a first display style to indicate that the pet virtual character is in the capturable state, and (ii) a second display style, different from the first, to indicate that the pet virtual character is not in the capturable state.

3. The method according to claim 1, wherein the capture threshold is dynamically adjusted such that the capture threshold changes in real time based on one or more factors of the virtual world, the dynamic adjustment being visualized by the position of the prompt element along the status bar.

4. The method according to claim 3, wherein the dynamic adjustment of the capture threshold is based on at least one environmental factor of the virtual world, the at least one environmental factor comprising at least one of a weather condition or a plot in which the pet virtual character is located.

5. The method of claim 3, wherein the dynamic adjustment of the capture threshold is based on a friendly interactive operation performed by the master virtual character, the friendly interactive operation comprising at least one of feeding the pet virtual character or healing the pet virtual character.

6. The method according to claim 1, wherein an initial value of the capture threshold is based on at least one of: a type or level of the pet virtual character, a number of historical capture times of the pet virtual character by the master virtual character, a personality matching degree between the master virtual character and the pet virtual character, or a gender matching degree between the master virtual character and the pet virtual character.

7. The method according to claim 3, wherein a secondary behavior of the pet virtual character is triggered in response to the capture threshold reaching a predetermined stage value, the secondary behavior comprising one of casting a friendly skill or adjusting a skill intensity.

8. The method of claim 1, further comprising displaying a second status bar representing a degree of satisfaction of the pet virtual character, wherein the second status bar indicates that the pet virtual character is in the capturable state when the second status bar is full.

9. The method of claim 8, wherein the degree of satisfaction of the pet virtual character (i) is decreased in response to an attack on the pet virtual character and (ii) is increased in response to a friendly operation.

10. The method of claim 3, wherein a change in a capture success rate of the pet virtual character is visually indicated by the change in the position of the prompt element along the status bar.

11. An apparatus for displaying capture information in a virtual world, the apparatus comprising:
at least one memory configured to store program code; and
at least one processor configured to read the program code and operate as instructed by the program code, the program code comprising:
pet display code configured to cause at least one of the at least one processor to display a pet virtual character within a virtual world;
status bar display code configured to cause at least one of the at least one processor to display a status bar corresponding to status information of the pet virtual character, the status information comprising a status value corresponding to at least one of an energy value or health points;
threshold determination code configured to cause at least one of the at least one processor to determine a capture threshold for the pet virtual character;
prompt display code configured to cause at least one of the at least one processor to display a prompt element on the status bar at a position corresponding to the capture threshold;
capture operation code configured to cause at least one of the at least one processor to receive a capture operation performed by a master virtual character on the pet virtual character; and
capture success code configured to cause at least one of the at least one processor to display capture success in response to the capture operation when the pet virtual character is in a capturable state, wherein the pet virtual character is in the capturable state when the status value is less than the capture threshold.

12. The apparatus of claim 11, wherein the prompt display code is configured to cause at least one of the at least one processor to display the prompt element in (i) a first display style to indicate that the pet virtual character is in the capturable state, and (ii) a second display style, different from the first, to indicate that the pet virtual character is not in the capturable state.

13. The apparatus of claim 11, wherein the threshold determination code is configured to cause at least one of the at least one processor to dynamically adjust the capture threshold such that the capture threshold changes in real time based on one or more factors of the virtual world, and wherein the prompt display code is configured to cause at least one of the at least one processor to visualize the dynamic adjustment by changing the position of the prompt element along the status bar.

14. The apparatus of claim 13, wherein the threshold determination code is configured to cause at least one of the at least one processor to base the dynamic adjustment of the capture threshold on at least one environmental factor of the virtual world, the at least one environmental factor comprising at least one of a weather condition or a plot in which the pet virtual character is located.

15. The apparatus of claim 13, wherein the threshold determination code is configured to cause at least one of the at least one processor to base the dynamic adjustment of the capture threshold on a friendly interactive operation performed by the master virtual character, the friendly interactive operation comprising at least one of feeding the pet virtual character or healing the pet virtual character.

16. The apparatus of claim 11, wherein the threshold determination code is configured to cause at least one of the at least one processor to base an initial value of the capture threshold on at least one of: a type or level of the pet virtual character, a number of historical capture times of the pet virtual character by the master virtual character, a personality matching degree between the master virtual character and the pet virtual character, or a gender matching degree between the master virtual character and the pet virtual character.

17. The apparatus of claim 13, wherein the program code further comprises secondary behavior code configured to cause at least one of the at least one processor to trigger a secondary behavior of the pet virtual character in response to the capture threshold reaching a predetermined stage value, the secondary behavior comprising one of casting a friendly skill or adjusting a skill intensity.

18. The apparatus of claim 11, wherein the program code comprises second status bar display code configured to cause at least one of the at least one processor to display a second status bar representing a degree of satisfaction of the pet virtual character, wherein the second status bar indicates that the pet virtual character is in the capturable state when the second status bar is full.

19. The apparatus of claim 18, wherein the second status bar display code is configured to cause at least one of the at least one processor to (i) decrease the degree of satisfaction of the pet virtual character in response to an attack on the pet virtual character and (ii) increase the degree of satisfaction in response to a friendly operation.

20. A non-transitory computer-readable storage medium storing program code which, when executed by at least one processor of a computer device, causes the at least one processor to at least:
display a pet virtual character within a virtual world;
display a status bar corresponding to status information of the pet virtual character, the status information comprising a status value corresponding to at least one of an energy value or health points;
determine a capture threshold for the pet virtual character;
display a prompt element on the status bar at a position corresponding to the capture threshold;
receive a capture operation performed by a master virtual character on the pet virtual character; and
display capture success in response to the capture operation when the pet virtual character is in a capturable state, wherein the pet virtual character is in the capturable state when the status value is less than the capture threshold.
